(19) United States
(12) Patent Application Publication
(10) Pub. No.: US 2016/0277878 A1
(43) Pub. Date: Sep. 22, 2016

(54) METHOD FOR COMMUNICATING DATA AND ELECTRONIC DEVICE THEREOF

(71) Applicant: Samsung Electronics Co., Ltd., Gyeonggi-do (KR)

(72) Inventor: Jae-Hyeok Lee, Gyeonggi-do (KR)

(21) Appl. No.: 15/072,219

(22) Filed: Mar. 16, 2016

(30) Foreign Application Priority Data
Mar. 16, 2015 (KR) 10-2015-0036074

(51) Int. Cl. H04W 4/00; H04W 76/02

(52) U.S. Cl. CPC H04W 4/008; H04W 76/023; H04W 76/025

(57) ABSTRACT

An operation method of an electronic device. The method includes establishing a first communication link with another electronic device using a first short-range wireless communication method, receiving information using at least one usable short-range wireless communication method from the other electronic device through the first communication link, selecting a second short-range wireless communication method from the at least one usable short-range wireless communication method included in the received information, establishing a second communication link with the other electronic device using the second short-range wireless communication method, and transmitting data to the other electronic device over the second communication link or receiving data from the other electronic device over the second communication link.

### CROSS-REFERENCE TO RELATED APPLICATION AND CLAIM OF PRIORITY

The present application is related to and claims benefit under 35 U.S.C. §119 to an application filed in the Korean Intellectual Property Office on Mar. 16, 2015 and assigned Serial No. 10-2015-0036074, the contents of which are incorporated herein by reference.

### TECHNICAL FIELD

Exemplary embodiments of the present disclosure relate to a method for communicating data in an electronic device and an electronic device thereof.

### BACKGROUND

An electronic device is connected with at least one another electronic device through a communication network to transmit or receive a user's voice, information used in the electronic device, or information located within the communication network in the form of data. In transmitting and receiving (such as transceiving) data with the other electronic device connected through the communication network, the electronic device may use a cellular communication protocol to communicate data through a repeater of a mobile network operator which provides a communication service, or may communicate data by directly connecting with the other electronic device using a short-range wireless communication protocol through a specific communication module included in the electronic device. When connecting with the other electronic device, the electronic device may use the same communication method as that of the other electronic device. A user should select a communication method to use and connect two electronic devices with each other (for example, the electronic device and another electronic device). In this case, when the communication method selected by the user is not supported by another electronic device, there is a problem that the connection is not established.

SUMMARY

To address the above-discussed deficiencies, it is a primary object to provide at least the advantages described below. Accordingly, an aspect of the present disclosure provides a method and apparatus for communicating data in an electronic device, in which a first electronic device and a second electronic device automatically determine at least one communication method using a first communication method, and establish a communication link, thereby providing convenience to a user.

According to an aspect of the present disclosure, an operation method of an electronic device includes: establishing a first communication link using a first short-range wireless communication method when another electronic device is detected; receiving information on at least one usable short-range wireless communication method from the another electronic device through the first communication link; determining a second short-range wireless communication method from among the at least one short-range wireless communication method included in the received information; establishing a second communication link with the another electronic device based on the second short-range wireless communication method; and transmitting and/or receiving data to and/or from the another electronic device using the second communication link.

According to another aspect of the present disclosure, an electronic device includes: at least one communication module; and a processor configured to: establish a first communication link using a first short-range wireless communication method when another electronic device is detected; receive information on at least one usable short-range wireless communication method from the another electronic device through the first communication link; determine a second short-range wireless communication method from among the at least one short-range wireless communication method included in the received information; establish a second communication link with the another electronic device based on the second short-range wireless communication method; and transmit and/or receive data to and/or from the another electronic device using the second communication link.

According to another aspect of the present disclosure, an electronic device includes a computer-readable storage medium which stores a program for performing a method, the method including: establishing a first communication link using a first short-range wireless communication method when another electronic device is detected; receiving information on other short-range wireless communication methods usable in the another electronic device through the first communication link; selecting a second short-range wireless communication method from among the other short-range wireless communication methods included in the received information; establishing a second communication link with the another electronic device based on the second short-range wireless communication method; and transmitting or receiving data to or from the another electronic device using the second communication link.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts

FIG. 1 illustrates a view showing a network environment including an electronic device according to various exemplary embodiment of the present disclosure;

FIG. 2 illustrates a block diagram showing an electronic device according to various exemplary embodiments of the present disclosure;

FIG. 3 illustrates a view showing a structure of data that is transceived in a communication connecting operation of an electronic device according to various exemplary embodiment of the present disclosure;

FIG. 4 illustrates a flowchart showing an operation of setting a communication environment in an electronic device according to various exemplary embodiment of the present disclosure;

FIG. 5 illustrates a flowchart showing an operation of determining a communication method for connecting with another electronic device in an electronic device according to various exemplary embodiment of the present disclosure;

FIG. 6 illustrates a flowchart showing an operation of determining a communication method for connecting with another electronic device in an electronic device according to various exemplary embodiment of the present disclosure;

FIG. 7 illustrates a view showing transceiving data through short-range wireless communication connected with another electronic device in an electronic device according to various exemplary embodiment of the present disclosure; and

FIG. 8 illustrates a view showing transceiving data through short-range wireless communication connected with another electronic device in an electronic device according to various exemplary embodiment of the present disclosure.

### DETAILED DESCRIPTION

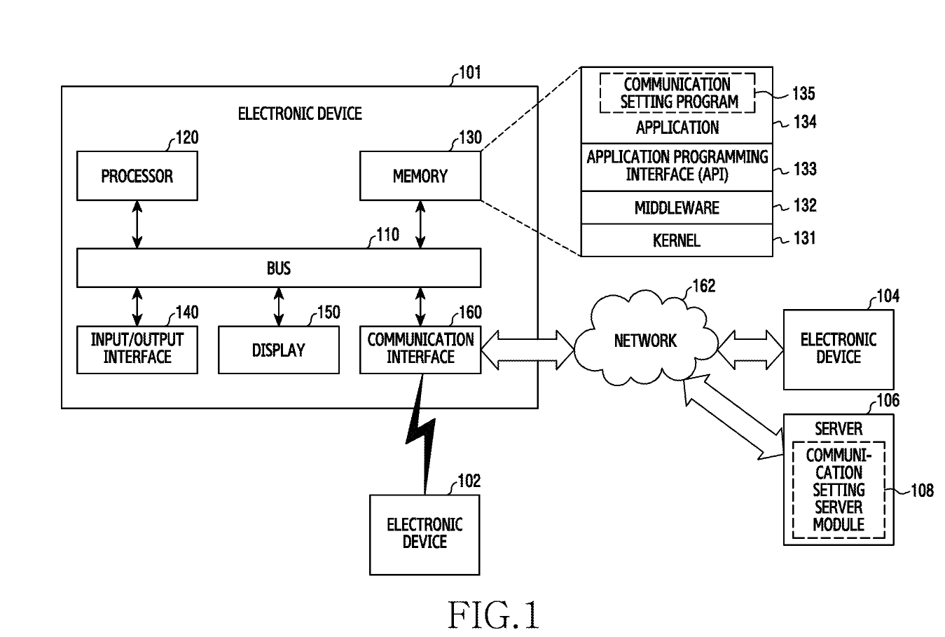

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic devices. Exemplary embodiments of the present disclosure will be described herein below with reference to the accompanying drawings. In the following description, detailed descriptions of well-known functions or configurations will be omitted since they would unnecessarily obscure the subject matters of the present disclosure. Also, the terms used herein are defined according to the functions of the present disclosure. Thus, the terms may vary depending on users' or operators' intentions or practices. Therefore, the terms used herein should be understood based on the descriptions made herein.

Exemplary embodiments of the present disclosure will be described herein below with reference to the accompanying drawings. Although specific embodiments of the present disclosure are illustrated in the drawings and relevant detailed descriptions are provided, various changes can be made and various exemplary embodiments may be provided. Accordingly, the various exemplary embodiments of the present disclosure are not limited to the specific embodiments and should be construed as including all changes and/or equivalents or substitutes included in the ideas and technological scopes of the exemplary embodiments of the present disclosure. In the explanation of the drawings, similar reference numerals are used for similar elements.

The terms “include” or “may include” used in the exemplary embodiments of the present disclosure indicate the presence of disclosed corresponding functions, operations, elements, and the like, and do not limit additional one or more functions, operations, elements, and the like. In addition, it should be understood that the terms “include” or “has” used in the exemplary embodiments of the present disclosure are to indicate the presence of features, numbers, steps, operations, elements, parts, or a combination thereof described in the specifications, and do not preclude the presence or addition of one or more other features, numbers, steps, operations, elements, parts, or a combination thereof.

The term “or” or “at least one of A or/and B” used in the exemplary embodiments of the present disclosure include any and all possible combinations of words enumerated with them. For example, “A or B” or “at least one of A or/and B” mean including A, including B, or including both A and B.

The terms such as “first” and “second” used in the various exemplary embodiments of the present disclosure may modify various elements of various exemplary embodiments, and does not limit the corresponding elements. For example, these terms do not limit the order and/or importance of the corresponding elements. These terms may be used for the purpose of distinguishing one element from another element. For example, a first user device and a second user device all indicate user devices and may indicate different user devices. For example, a first element may be named a second element without departing from the scope of right of the various exemplary embodiments of the present disclosure, and similarly, a second element may be named a first element.

It will be understood that when an element is “connected” or “coupled” to another element, the element may be directly connected or coupled to another element, and there may be an intervening element between the element and another element. To the contrary, it will be understood that when an element is “directly connected” or “directly coupled” to another element, there is no intervening element between the element and another element.

The terms is used in the various exemplary embodiments of the present disclosure are for the purpose of describing particular exemplary embodiments only and are not intended to limit the present disclosure. As used herein, the singular forms are intended to include the plural forms as well, unless the context clearly indicates otherwise. All of the terms used herein including technical or scientific terms have the same meanings as those generally understood by an ordinary skilled person in the related art unless they are defined otherwise. The terms defined in a generally used dictionary should be interpreted as having the same meanings as the contextual meanings of the relevant technology and should not be interpreted as having ideal or exaggerated meanings unless they are clearly defined in the various exemplary embodiments.

An electronic device according to various exemplary embodiments of the present disclosure may be a device which is equipped with a communication function. For example, the electronic device may include at least one of a smartphone, a tablet personal computer (PC), a mobile phone, a video phone, an electronic book reader, a desktop PC, a laptop PC, a netbook computer, a personal digital assistant (PDA), a portable multimedia player (PMP), an MP3 player, a mobile medical machine, a camera, or a wearable device (such as a head-mounted-device (HMD) such as electronic glasses, electronic clothing, an electronic bracelet, an electronic necklace, an electronic appccessory, electronic tattoos, or a smartwatch).

According to an exemplary embodiment, the electronic device may be a smart home appliance which is equipped with a communication function. For example, the smart home appliance may include at least one of a television, a digital video disk (DVD) player, a stereo, a refrigerator, an air conditioner, a cleaner, an oven, a microwave oven, a washing machine, an air cleaner, a set-top box, a TV box (such as Samsung HomeSync™, Apple TV™, or Goggle TV™), a game console, an electronic dictionary, an electronic key, a camcorder, or an electronic album.

According to an exemplary embodiment, the electronic device may include at least one of various medical machines (such as magnetic resonance angiography (MRA), magnetic resonance imaging (MRI), computerized tomography (CT), a tomograph, an ultrasound machine, and the like), a navigation device, a global positioning system (GPS) receiver, an event data recorder (EDR), a flight data recorder (FDR), an automotive infotainment device, electronic equipment for ship (such as navigation equipment for ship, a gyro compass, and the like), avionics, a security device, a head unit for vehicles, an industrial or home robot, an automatic teller machine (ATM) of a financial institution, or point of sales (POS) of a store.

According to an exemplary embodiment, the electronic device may include at least one of a part of furniture or a building/a structure equipped with a communication function, an electronic board, an electronic signature receiving device, a projector, and various measurement devices (such as water, power, gas, or radio waves measurement devices). The electronic device according to various exemplary embodiment of the present disclosure may be one or a combination of one or more of the above-mentioned devices. In addition, the electronic device according to various exemplary embodiments of the present disclosure may be a flexible device. In addition, it is obvious to an ordinary skilled person in the related art that the electronic device according to various exemplary embodiments of the present disclosure is not limited to the above-mentioned devices.

Hereinafter, an electronic device according to various exemplary embodiments will be explained with reference to the accompanying drawings. The term “user” used in various exemplary embodiments may refer to a person who uses the electronic device or a device which uses the electronic device (for example, an artificial intelligence electronic device).

FIG. 1 illustrates a view showing a network environment including an electronic device according to various exemplary embodiments.

Referring to FIG. 1, the electronic device 101 may include at least one of a bus 110, a processor 120, a memory 130, an input and output interface 140, a display 150, or a communication interface 160.

The bus 110 may be a circuit which connects the above-described elements with one another and transmits communication signals (for example, a control message) between the above-described elements.

The processor 120 may receive instructions from the other elements (for example, the memory 130, the input and output interface 140, the display 150, or the communication interface 160) via the bus 110, decipher the instructions, and perform calculation or data processing according to the deciphered instructions.

At least one processor 120 may be included in the electronic device 101 to perform a designated function of the electronic device 101. According to an exemplary embodiment, the processor 120 may include one or more application processors (APs) and one or more micro controller unit (MCUs). According to another exemplary embodiment, the processor 120 may include one or more MCUs as an application or may be functionally connected with one or more MCUs. In FIG. 1, the AP and the MCU may be included in a single IC package or may be configured separately and included in different IC packages. According to an exemplary embodiment, the MCU may be included in an IC package of the AP and thus may be configured as a single IC package. The processor 120 includes the AP or the MCU as its element, but this is merely an exemplary embodiment for easy understanding of the present disclosure. It would be obvious that the processor 120 performs the operation of the AP and/or the MCU.

The AP may control a plurality of hardware or software elements connected thereto by driving an operating system or an application program (or an application), and may process and calculate various data including multimedia data. The AP may be implemented by using a system on chip (SoC). According to an exemplary embodiment, the processor 120 may further include a graphic processing unit (GPU) (not shown).

The MCU may be a processor which is set to perform a designated operation. According to an exemplary embodiment, the MCU may acquire sensing information through one or more designated motion sensors (for example, a gyro sensor, an acceleration sensor, or a geomagnetic sensor), compare the acquired sensing information, and determine an operation state of the designated sensor with reference to a database of the electronic device 101.

According to an exemplary embodiment, the AP or the MCU may load instructions or data which is received from a non-volatile memory connected thereto or at least one of the other elements into a volatile memory, and process the instructions or data. In addition, the AP or the MCU may store data which is received from or generated by at least one of the other elements in the non-volatile memory.

The memory 130 (for example, a memory 230) may store instructions or data which is received from or generated by the processor 120 or the other elements (for example, the input and output interface 140, the display 150, the communication interface 160). For example, the memory 130 may include programming modules such as a kernel 131, middleware 132, an Application Programming Interface (API) 133, an application 134, and the like. Each of the above-described programming modules may be configured by software, firmware, hardware, or a combination of two or more of them.

The kernel 131 may control or manage system resources (for example, the bus 110, the processor 120, the memory 130, or the like) which are used for performing operations or functions implemented in the other programming modules, for example, the middleware 132, the API 133, or the application 134. In addition, the kernel 131 may provide an interface for allowing the middleware 132, the API 133, or the application 134 to access an individual element of the electronic device 101 and control or manage the element.

The middleware 132 may serve as an intermediary to allow the API 133 or the application 134 to communicate with the kernel 131 and exchange data with the kernel 131. In addition, the middleware 132 may perform controlling (for example, scheduling or load balancing) with respect to work requests received from the application 134, for example, by giving a priority to use the system resources of the electronic device 101 (for example, the bus 110, the processor 120, the memory 130, or the like) to at least one of the applications 134.

The API 133 is an interface for allowing the application 134 to control a function provided by the kernel 131 or the middleware 132, and, for example, may include at least one interface or function (for example, instructions) for controlling a file, controlling a window, processing an image, or controlling a text.

The application (or processor) 134 may include a short message service (SMS)/multimedia messaging service (MMS) application, an email application, a calendar application, an alarm application, a health care application (for example: an application for measuring exercise or a blood glucose), an environment information application (for example: an application for providing information on atmospheric pressure, humidity, or temperature), and the like. The application (or processor) 134 may be an application related to information exchange between the electronic device 101 and an external electronic device (for example: an electronic device 102 or an electronic device 104). For example, the application related to the information exchange may include a notification relay application for relaying specific information to the external electronic device or a device management application for managing the external electronic device. For example, the notification relay application may include a function of relaying notification information generated in other applications of the electronic device 101 (for example: the SMS/MMS application, the email application, the health care application, the environment information application, and the like) to an external electronic device (for example: the electronic device 104).

Additionally or alternatively, the notification relay application may receive notification information from the external electronic device (for example: the electronic device 104) and may relay the same to the user. For example, the device management application may manage (for example: install, delete or update) a function regarding at least part of the external electronic device (for example: the electronic device 104) communicating with the electronic device 101 (for example: turning on/off the external electronic device (or some parts) or adjusting brightness of a display), an application operating in the external electronic device or a service provided by the external electronic device (for example: a calling service or a message service). According to various exemplary embodiments, the application 134 may include an application specified according to an attribute (for example: a kind of an electronic device) of the external electronic device (for example: the electronic device 102 or the electronic device 104). For example, when the external electronic device is an MP3 player, the application 134 may include an application related to music replay. Similarly, when the external electronic device is a mobile medical device, the application 134 may include an application related to health care. According to an exemplary embodiment, the application 134 may include at least one of an application specified by the electronic device 101 or an application received from the external electronic device (for example: a server 106 or the electronic device 104). A communication setting program 135 may be included in the application 134 and provided, or may be stored in the memory 130 as a separate program.

The communication setting program 135 may control a first communication module to connect with the electronic device 102 (for example, another electronic device or a counterpart electronic device) in a near field communication (NFC) method, identify connectable short-range wireless communication information of the electronic device 102 in the connecting process, set a short-range wireless communication method for the electronic device 102. and control one of a second communication module and a third communication module according to the set short-range wireless communication method to transmit or receive data to or from the electronic device 102. According to an exemplary embodiment, the communication setting program 135 may control the first communication module to use a logical link control protocol according to the NFC method, and connect with the electronic device 102 by exchanging records including a type, a length, and a value according to the logical link control protocol.

According to various exemplary embodiments, the communication setting program 135 may control the first communication module to establish a first communication link when a signal for connecting with the external electronic device 102 through network communication is detected, receive second communication information of a connectable short-range wireless communication type from the external electronic device 102 through the first communication link, control the second communication module based on the second communication information to set a second communication link with the external electronic device 102, and transmit or receive data to or from the external electronic device 102 through the second communication link. According to an exemplary embodiment, the communication setting program 135 may detect the signal for connecting with the electronic device 102 through network communication by contacting the electronic device 102. According to an exemplary embodiment, the first communication link may be NFC. According to an exemplary embodiment, the second communication information may be a value including at least one of types of short-range wireless communication of the second electronic device for connecting with the first electronic device.

According to an exemplary embodiment, at least one of the records may include at least one of values indicating that the electronic device 102 is connectable only through short-range wireless communication of a Bluetooth(BT) communication method, or indicating that the electronic device 102 is connectable through both the short-range wireless communication of the BT communication method and the short-range wireless communication of a wireless fidelity (WiFi) communication method. According to an exemplary embodiment, the first communication module may be an NFC module, the second communication module may be a BT communication module, and the third communication module may be a WiFi communication module. According to an exemplary embodiment, when it is determined that the electronic device 102 is connectable only through the BT communication based on the identified short-range wireless communication information, the communication setting program 135 may set the short-range wireless communication method for the electronic device 102 as the BT communication. According to an exemplary embodiment, when it is determined that the electronic device 102 is connectable through both the BT communication and the WiFi-Direct communication based on the identified short-range wireless communication information, the communication setting program 135 may set the short-range wireless communication method for the electronic device 102 as the WiFi-Direct communication. According to an exemplary embodiment, when the electronic device 102 is connectable through both the BT communication and the WiFi-Direct communication, both the BT communication and the WiFi-Direct communication may be activated in the process of connecting with the electronic device. According to an exemplary embodiment, when the set short-range wireless communication method is the BT communication, the communication setting program 135 may control a BT communication module to transmit or receive data to or from the electronic device 102. According to an exemplary embodiment, when the set short-range wireless communication method is the WiFi-Direct communication, the communication setting program 135 may control a WiFi-Direct communication module to transmit or receive data to or from the electronic device 102.

According to various exemplary embodiments, the communication setting program 135 may establish a first communication link using a first short-range wireless communication method when detecting another electronic device, receive information on other short-range wireless communication methods usable by another electronic device through the first communication link, select a second short-range wireless communication method from among the other short-range wireless communication methods included in the received information, establish a second communication link with another electronic device based on the second short-range wireless communication method, and transmit or receive data to or from another electronic device using the second communication link. According to an exemplary embodiment, the communication setting program 135 may detect another electronic device by detecting contact with another electronic device. According to an exemplary embodiment, the communication setting program 135 may control an NFC module which uses an NFC method as the first short-range wireless communication method. According to an exemplary embodiment, the communication setting program 135 may control at least one of WiFi, WiFi-Direct, and BT methods as at least one short-range wireless communication method. According to an exemplary embodiment, the communication setting program 135 may acquire, from the information, at least one of values indicating that another electronic device is connectable only through the first short-range wireless communication or that another electronic device is connectable through both the first short-range wireless communication and the second short-range wireless communication. According to an exemplary embodiment, the communication setting program 135 may receive the information on the other wireless communication methods usable by another electronic device, which includes a type-length-value (TLV) record generated based on an logical link control (LLC) protocol, through the first communication link. According to an exemplary embodiment, the communication setting program 135 may identify the other short-range wireless communication methods based on information included in at least one of type or tag, length, and value fields of the TLV record. According to an exemplary embodiment, the communication setting program 135 may control a WiFi module which uses the WiFi-Direct method as the second short-range wireless communication method. According to an exemplary embodiment, when it is determined that another electronic device is connectable through both the BT method and the WiFi-Direct method based on the information on the other short-range wireless communication methods, the communication setting program 135 may select the WiFi-Direct method as the second short-range wireless communication method.

The input and output interface 140 may transmit instructions or data input by the user through an input and output device (for example: various sensors such as an acceleration sensor or a gyro sensor and/or a device such as a keyboard or a touch screen) to the processor 120, the memory 130, or the communication interface 160 through the bus 10, for example. For example, the input and output interface 140 may provide data on a user's touch input through a touch screen to the processor 120. In addition, the input and output interface 140 may output instructions or data received from the processor 120, the memory 130, or the communication interface 160 through the bus 110 through an output device (for example: a speaker or a display). For example, the input and output interface 140 may output audio data processed by the processor 120 to the user through a speaker.

The display 150 may display a variety of information (for example: multimedia data, text data, or the like) for the user. In addition, the display 150 may be configured as a touch screen through which the user inputs instructions by touching or approaching the display with an inputting means.

The communication interface 160 (for example, a communication module 220) may connect communication between the electronic device 101 and an external device (for example: the electronic device 104 or the server 106). For example, the communication interface 160 may be connected to a network 162 via wireless communication or wire communication to communicate with the external device. The wireless communication may include at least one of WiFi, WiFi-Direct, BT, NFC, global positioning system (GPS), or cellular communication (for example: LTE, LIE-A, CDMA, WCDMA, UMTS, WiBro, GSM, or the like). The wire communication may include at least one of a universal serial bus (USB), a high definition multimedia interface (HDMI), a recommended standard 232 (RS-232), or a plain old telephone service (POTS).

According to an exemplary embodiment, the network 162 may be a telecommunications network. The telecommunications network may include at least one of a computer network, the Internet, Internet of things, or a telephone network. According to an exemplary embodiment, a protocol for communicating between the electronic device 101 and the external device (for example: a transport layer protocol, a data link layer protocol or a physical layer protocol) may be supported in at least one of the application 134, the application programming interface 133, the middleware 132, the kernel 131, or the communication interface 160.

According to an exemplary embodiment, the server 106 may support the driving of the electronic device 101 by performing at least one of the operations (or functions) implemented in the electronic device 101. For example, the server 106 may include a server circuitry (for example, a server controller or a server processor (not shown)) to support the processor 120 which controls the electronic device 101 to perform various exemplary embodiments of the present disclosure, which will be described below, or a specific module which is designated to perform various exemplary embodiments. For example, the server circuitry may include at least one element of the processor 120 or the specific module to perform at least one operation of the operations performed by the processor 120 or the specific module (for example, on behalf of the processor 120 or the specific module). According to various exemplary embodiments, the server module may be expressed by a communication setting server module 108 shown in FIG. 1.

According to various exemplary embodiments, the electronic device 101 may connect network communication (for example, short-range wireless communication) with the electronic device 102 in a 1:1 direct communication method (for example, point to point). However, connecting the electronic device 101 to the electronic device 102 through network communication is not limited to the 1:1 direct communication, and various communications such as peer to peer (PtoP, P2P) communication or end to end communication may be applied.

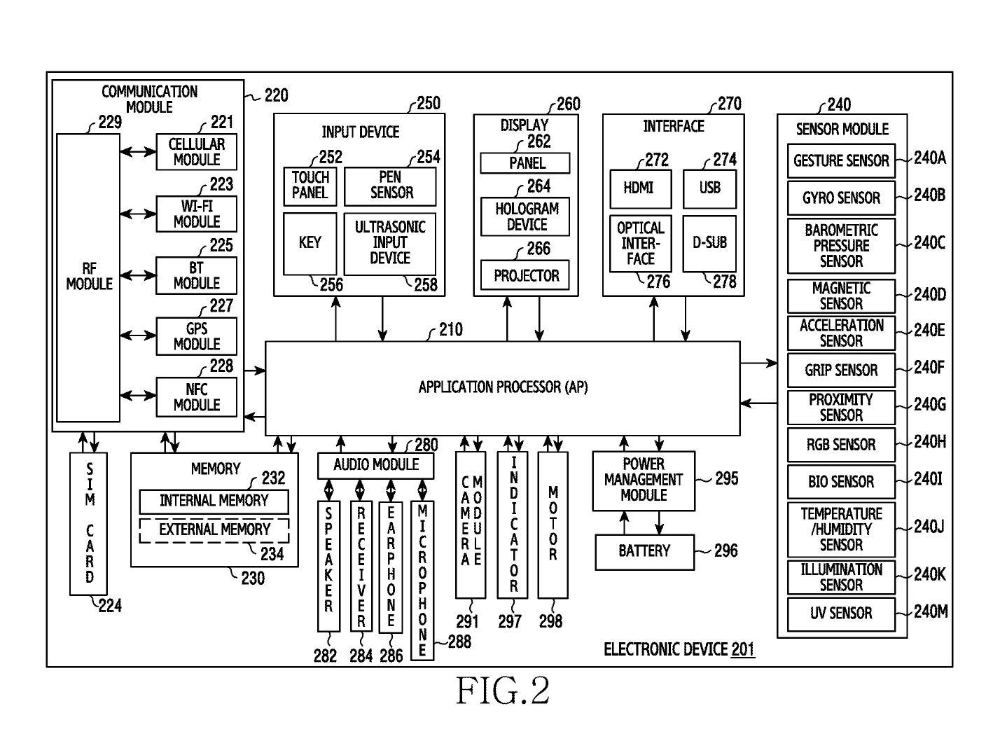

Additional information regarding the electronic device 101 will be provided with reference to FIGS. 2 to 8.

FIG. 2 illustrates a block diagram showing an electronic device according to various exemplary embodiments of the present disclosure.

The electronic device 201 may include the entirety or part of the electronic device 101 shown in FIG. 1, or may extend the entirety or part of the electronic device 101. Referring to FIG. 2, the electronic device 201 may include at least one application processor (AP) 210, a communication module 220, a subscriber identification module (SIM) card 224, a memory 230, a sensor 240, an input device 250, a display 260, an interface 270, an audio 280, a camera 291, a power management 295, a battery 296, an indicator 297, or a motor 298.

At least one application processor 210 may be included in the electronic device 101 to perform a designated function of the electronic device 101. According to an exemplary embodiment, the application processor 210 may include one or more APs and one or more MCUs. According to another exemplary embodiment, the application processor 210 may include one or more MCUs as an application or may be functionally connected with one or more MCUs. In FIG. 1, the AP and the MCU may be included in a single IC package or may be configured separately and included in different IC packages. According to an exemplary embodiment, the MCU may be included in an IC package of the AP and thus may be configured as a single IC package. The application processor 210 includes the AP or the MCU as its element, but this is merely an exemplary embodiment for easy understanding of the present disclosure. It would be obvious that the application processor 210 performs the operation of the AP and/or the MCU.

The AP may control a plurality of hardware or software elements connected thereto by driving an operating system or an application program (or an application), and may process and calculate various data including multimedia data. The AP may be implemented by using a SoC. According to an exemplary embodiment, the application processor 210 may further include a GPU (not shown).

The MCU may be a processor which is set to perform a designated operation. According to an exemplary embodiment, the MCU may acquire sensing information through one or more designated motion sensors (for example, a gyro sensor 240b, an acceleration sensor 240e, or a geomagnetic sensor (not shown)), compare the acquired sensing information, and determine an operation state of the designated sensor (for example, a geomagnetic sensor (not shown) with reference to a database of the electronic device 101. Furthermore, in FIG. 2, the MCU and the elements of the sensor 240 are illustrated as the MCU and separate elements from the MCU. However, according to an exemplary embodiment, the MCU may be implemented to include at least some of the elements of the sensor 240 described above (for example, at least one of the gyro sensor 240b, the acceleration sensor 240e, and the geomagnetic sensor (not shown)).

According to an exemplary embodiment, the AP or the MCU may load instructions or data which is received from a non-volatile memory connected thereto or at least one of the other elements into a volatile memory, and process the instructions or data. In addition, the AP or the MCU may store data which is received from or generated by at least one of the other elements in the non-volatile memory.

The communication module 220 (for example, the communication interface 160) may exchange data in communication between the electronic device 101 and other electronic devices (for example, the electronic device 102, the electronic device 104, or the server 106) connected with the electronic device 101 through a network. According to an exemplary embodiment, the communication module 220 may include a cellular module 221, a WiFi module 223, a BT module 225, a GPS module 227, an NFC module 228, and a radio frequency (RF) 229.

The cellular module 221 may provide a voice call, a video call, a text service, or an Internet service through a telecommunications network (for example, LTE, LTE-A, CDMA, WCDMA, UMTS, WiBro, GSM, or the like). In addition, the cellular module 221 may identify and authenticate the electronic device in the telecommunications network by using a subscriber identification module (for example, the SIM card 224). According to an exemplary embodiment, the cellular module 221 may perform at least some of the functions provided by the AP 210. For example, the cellular module 221 may perform at least some of the multimedia control functions.

According to an exemplary embodiment, the cellular module 221 may include a communication processor (CP). In addition, the cellular module 221 may be implemented by using a SoC. In FIG. 2, the cellular module 221 (for example, the CP), the memory 230, the power management 295, etc. are illustrated as separate elements from the AP 210. However, according to an exemplary embodiment, the AP 210 may be implemented to include at least some of the above-described elements (for example, the cellular module 221).

According to an exemplary embodiment of the present disclosure, the AP 210 or the cellular module 221 (for example, the CP) may load instructions or data which is received from a non-volatile memory connected therewith or at least one of the other elements into a volatile memory, and process the instructions or the data. In addition, the AP 210 or the cellular module 221 may store data which is received from or generated by at least one of the other elements in the non-volatile memory.

The WiFi module 223, the BT module 225, the GPS module 227. or the NFC module 228 each may include a processor for processing data received and transmitted through a corresponding module. In FIG. 2, the cellular module 221, the WiFi module 223, the BT module 225, the GPS module 227, or the NFC module 228 are illustrated as separate blocks. However, according to an exemplary embodiment, at least some (for example, two or more) of the cellular module 221, the WiFi module 223, the BT module 225, the GPS module 227, or the NFC module 228 may be included in a single integrated chip (IC) or a single IC package. For example, at least some of the processors corresponding to the cellular module 221, the WiFi module 223, the BT module 225, the GPS module 227, or the NFC module 228 (for example, a communication processor corresponding to the cellular module 221 and a WiFi processor corresponding to the WiFi module 223) may be implemented by using a single SoC.

The RF 229 may transmit and receive data, for example, RF signals. Although not shown, the RF 229 may include a transceiver, a power amp module (PAM), a frequency filter, a low noise amplifier (LNA), etc. In addition, the RF 229 may further include a part for transmitting and receiving electromagnetic waves in a free space in wireless communication, for example, a conductor or conducting wire. In FIG. 2, the cellular module 221, the WiFi module 223, the BT module 225, the GPS module 227, and the NFC module 228 share the single RF module 229 with one another. However, according to an exemplary embodiment, at least one of the cellular module 221, the WiFi module 223, the BT module 225, the GPS module 227, or the NFC module 228 may transmit and receive RF signals through a separate RF.

The SIM card 224 may be a card including a subscriber identification module, and may be inserted into a slot formed on a specific location of the electronic device. The SIM card 224 may include unique identification information (for example, an integrated circuit card identifier (ICCID)) or subscriber information (for example, international mobile subscriber identity (IMSI)).

The memory 230 (for example, the memory 130) may include an internal memory 232 or an external memory 234. For example, the internal memory 232 may include at least one of a volatile memory (for example, a dynamic random access memory (DRAM), a static random access memory (SRAM), a synchronous DRAM (SDRAM), and the like) or a non-volatile memory (for example, an one-time programmable read only memory (OTPROM), a programmable read only memory (PROM), an erasable programmable read only memory (EPROM), an electrically erasable programmable read only memory (EEPROM), a mask ROM, a flash ROM, a NAND flash memory, a NOR flash memory, and the like).

According to an exemplary embodiment, the internal memory 232 may be a solid state drive (SSD). For example, the external memory 234 may further include a flash drive, for example, compact flash (CF), secure digital (SD), micro-SD, mini-SD, extreme-digital (xD), memory stick, and the like. The external memory 234 may be functionally connected with the electronic device 201 through various interfaces. According to an exemplary embodiment, the electronic device 201 may further include a storage device (or a storage medium) such as a hard drive.

The sensor 240 may measure a physical quantity or detect an operation state of the electronic device 201, and may convert measured or detected information into electric signals. The sensor 240 may include at least one of a gesture sensor 240A, a gyro sensor 240B, a barometric pressure sensor 240C, a magnetic sensor 240D, an acceleration sensor 240E, a grip sensor 240F, a proximity sensor 240G, a color sensor 240H (for example, red, green, blue (RGB) sensor), a biosensor 2401, a temperature/humidity sensor 240J, an illuminance sensor 240K, or a ultraviolet (UV) sensor 240M. Additionally or alternatively, the sensor 240 may include a geomagnetic sensor (not shown), an E-nose sensor (not shown), an electromyography (EMG) sensor (not shown), an electroencephalogram (EEG) sensor (not shown), an electrocardiogram (ECG) sensor (not shown), an infrared ray (IR) sensor, an iris sensor (not shown), or a fingerprint sensor (not shown), and the like. The sensor 240 may further include a control circuit to control at least one sensor included therein.

The input device 250 may include a touch panel 252, a (digital) pen sensor 254, a key 256, or an ultrasonic input device 258. The touch panel 252 may detect a touch input in at least one method of capacitive, resistive, infrared, and ultrasonic methods. In addition, the touch panel 252 may further include a control circuit. In the case of the capacitive, the input device 250 can detect a physical contact or hovering. The touch panel 252 may further include a tactile layer. In this case, the touch pane 252 may provide a tactile response to the user.

The (digital) pen sensor 254 may be implemented in the same or similar method as or to the method of receiving a user's touch input or by using a separate recognition sheet. The key 256 may include a physical button, an optical key, or a keypad, for example. The ultrasonic input device 258 is a device which allows the electronic device 201 to detect sound waves using a microphone (for example, the microphone 288) and identify data through an input tool generating ultrasonic signals, and is capable of detecting wirelessly. According to an exemplary embodiment, the electronic device 201 may receive a user input from an external device connected thereto (for example, a computer, or a server) using the communication module 220.

The display 260 (for example, the display 150) may include a panel 262, a hologram device 264, or a projector 266. For example, the panel 262 may be a Liquid Crystal Display (LCD) or an active matrix organic light emitting diode (AM-OLED). For example, the panel 262 may be implemented to be flexible, transparent, or wearable. The panel 262 may be configured as a single module along with the touch panel 252. The hologram device 264 may show a stereoscopic image in the air using interference of light. The projector 266 may display an image by projecting light onto a screen. The screen may be located inside or outside the electronic device 201. According to an exemplary embodiment, the display 260 may further include a control circuit to control the panel 262, the hologram device 264, or the projector 266.

The interface 270 may include a high definition multimedia interface (HDMI) 372, a universal serial bus (USB) 274, an optical interface 276, or a D-subminiature (D-sub) 278. For example, the interface 270 may include the communication interface 160 shown in FIG. 1. Additionally or alternatively, the interface 270 may include a mobile high-definition link (MHL) interface, a secure digital (SD) card/multimedia card (MMC) interface, or infrared data association (IrDA) standard interface.

The audio 280 may convert a sound and an electric signal bidirectionally. At least some elements of the audio 280 may be included in the input and output interface 140 shown in FIG. 1. For example, the audio 280 may process sound information which is input or output through a speaker 282, a receiver 284, an earphone 286, or a microphone 288. The camera 291 is a device for photographing a still image and a moving image. According to an exemplary embodiment, the camera 291 may include one or more image sensors (for example, a front surface sensor or a rear surface sensor), a lens, an image signal processor (ISP) (not shown), or a flash (memory) (for example, a light emitting diode (LED) or a xenon lamp).

The power management 295 may manage power of the electronic device 201. Although not shown, the power management 295 may include a power management IC (PMIC), a charger IC, or a battery or fuel gage. According to various exemplary embodiments, the PMIC may be mounted in an integrated circuit or an SoC semiconductor. The charging method may be divided into a wired charging method and a wireless charging method. The charger IC may charge a battery and may prevent inflow of overvoltage or over current from a charger.

According to an exemplary embodiment, the charger IC may include a charging IC for at least one of the wired charging method and the wireless charging method. The wireless charging method may include a magnetic resonance method, a magnetic induction method, or an electromagnetic wave method, and an additional circuit for charging wirelessly, for example, a circuit such as a coil loop, a resonant circuit, a rectifier, and the like may be added.

For example, the battery gage may measure a remaining battery life of the battery 296, a voltage, a current, or temperature during charging. The battery 296 may store or generate electricity and supply power to the electronic device 201 using the stored or generated electricity. The battery 296 may include a rechargeable battery or a solar battery.

The indicator 297 may display a specific state of the electronic device 201 or a part of the electronic device 201, for example, a booting state, a message state, or a state of charge (SOC). The motor 298 may convert an electric signal into a mechanical vibration. Although not shown, the electronic device 201 may include a processing device (for example, a GPU) for supporting a mobile TV. The processing device for supporting the mobile TV may process media data according to standards such as digital multimedia broadcasting (DMB), digital video Broadcasting (DVB), or media flow.

Each of the above-described elements of the electronic device according to various exemplary embodiments of the present disclosure may be comprised of one or more components, and the names of the elements may vary according to the kind of the electronic device. The electronic device according to various exemplary embodiments of the present disclosure may include at least one of the above-described elements, and some of the elements may be omitted or an additional element may be further included. In addition, some of the elements of the electronic device according to various exemplary embodiments of the present disclosure may be combined into a single entity, and may perform the same functions as those of the elements before being combined.

Hereinafter, the electronic device 101 will be explained as a first electronic device (or a first electronic device 101), and the electronic device 102 will be explained as a second electronic device (or a second electronic device 102). To explain the roles of the electronic device according to various exemplary embodiments, the electronic device 102 may be substituted with terms such as a counterpart device or another electronic device.

Furthermore, the electronic device 102, the electronic device 104, or the server 106 may be devices located outside the electronic device 101, and may be expressed as an external electronic device 102, an external electronic device 104, or an external server 106.

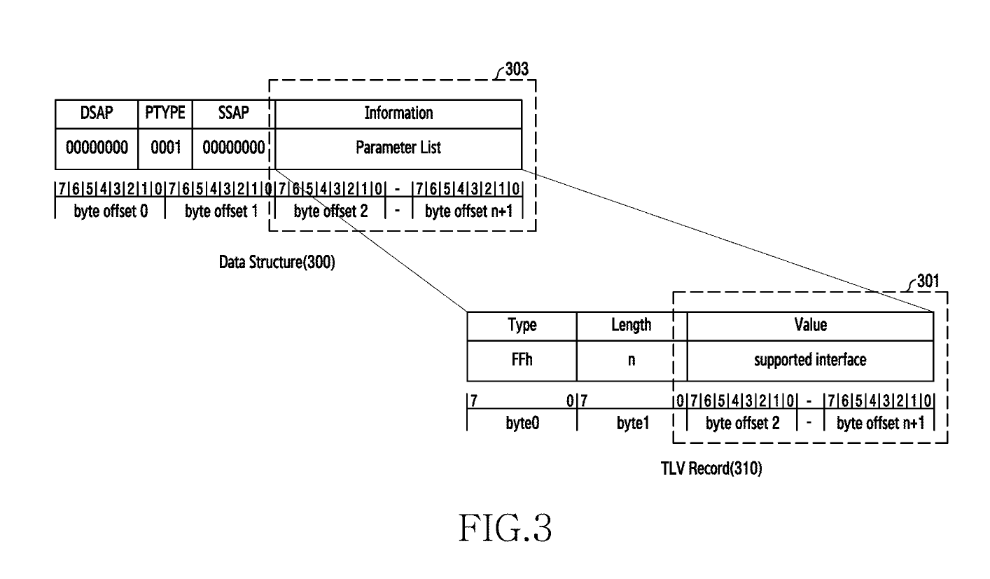

FIG. 3 illustrates a view showing a structure of data that is transceived in a communication connecting operation of the electronic device according to various exemplary embodiments.

According to various exemplary embodiments, when the first electronic device 101 contacts or approaches another electronic device (for example, the second electronic device 101, hereinafter, referred to as the second electronic device 102), the first electronic device 102 may perform communication of an NFC method. Herein, the operation of the first electronic device 101 contacting the second electronic device 102 may be defined as the first electronic device 101 and the second electronic device 102 being located within a distance where they can transceive data through the communication of the NFC method. For example, when the first electronic device 101 and the second electronic device 102 approach each other within a distance of 10 cm, the first electronic device 101 and the second electronic device 102 may be regarded as contacting each other.

According to various exemplary embodiments, when the first electronic device 101 detects contact with the second electronic device 102, the first electronic device 101 may establish a communication link of the NFC method with the second electronic device 102, and transceive data having the structure shown in FIG. 3. According to an exemplary embodiment, the first electronic device 101 may connect NFC with the second electronic device 102 and transceive data through a logical link control protocol (LLCP) (or an LLC protocol). In transceiving data with the second electronic device 102 through the LLC protocol, the first electronic device 101 may generate a TLV record 310 including a type or a tag, a length, and a value, and transceive data for connecting network communication between the first electronic device 101 and the second electronic device.

According to various exemplary embodiments, the type region of the TLV record 310 may include a type of information included in the value region of the TLV record 310. According to an exemplary embodiment, when the value region of the TLV record 310 includes information on a communication module included in the second electronic device 102, the type region of the TLV record 310 may include information indicating a type such as “communication.”

According to various exemplary embodiments, the length region of the TLV record 310 may include a data length (or a data size) of information included in the value region of the TLV record 310. The length region of the TLV record 310 may include the whole size of the TLV record 310.

According to various exemplary embodiments, the value region 301 of the TLV record 310 may include information on the communication module which is usable or connectable in the second electronic device 102. According to an exemplary embodiment, the value region of the TLV record 310 which is received from the second electronic device 102 connected with the first electronic device 101 through the NFC may include device identification information of the communication module included in the second electronic device 102, activation/inactivation state information, and information indicating whether the data is being transceived or not.

The first electronic device 101 may include the TLV record in at least one data of another format (for example, a PDU format) and transmit the TLV record as a method for transceiving the TLV record with the second electronic device 102. According to an exemplary embodiment, the first electronic device 101 may include the TLV record 310 in the data of the PDU format and transceive the TLV record 310 prior to or in the middle of transceiving an NFC data exchange format (NDEF) message through the communication link of the NFC method connected with the second electronic device 102.

As described above, in transceiving the information on the communication module usable or connectable in the first electronic device 101 and/or the second electronic device 102, the device identification information of the communication module included in the first electronic device 101 and/or the second electronic device 102, the activation/inactivation state information, and the information indicating whether data is being transceived or not with the second electronic device 102, the first electronic device 101 may include such information in the TLV record 310 and transmit the information. However, this should not be considered as limiting. The first electronic device 101 may generate data 300 of various structures or formats (for example, hierarchical structure data of a PDU format) which can be processed in the LLC protocol, and may transceive the data.

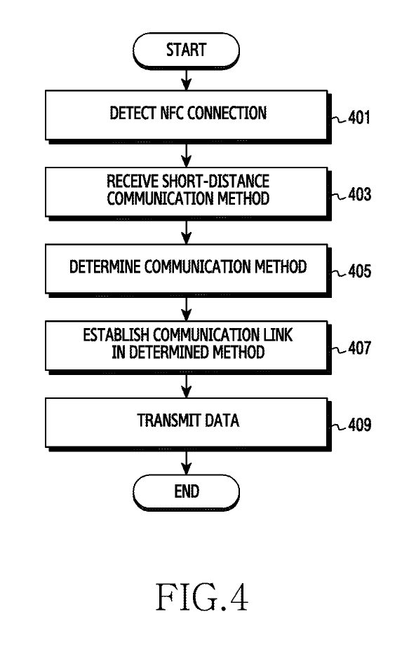

FIG. 4 illustrates a flowchart showing an operation of setting a communication environment in the electronic device according to various exemplary embodiments.

Referring to operation 401, when the first electronic device 101 contacts the second electronic device 102, the first electronic device 101 detects the contact. According to an exemplary embodiment, when the first electronic device 101 contacts the second electronic device 102, the first electronic device 101 may detect the contact by means of an NFC module, and establish an NFC link with the second electronic device 102. In connecting with the second electronic device 102 through the NFC, the first electronic device 101 may request the second electronic device 102 to transmit information on a usable communication module (or a usable communication method) included in the second electronic device 102 through the NFC

Referring to operation 403, the first electronic device 101 may receive the information on the usable communication module (or the usable communication method) from the second electronic device 102 connected therewith through the NFC. According to an exemplary embodiment, the first electronic device 101 may receive the information on the usable communication module (or the usable communication method) which is included in the TLV record. For example, the first electronic device 101 may generate the TLV record through a designated protocol of the NFC (for example, the LLC protocol), and transceive data with the second electronic device 102. The first electronic device 101 may identify the usable communication method of the second electronic device 102 based on information included in at least one of the type or tag, length, and value fields of the TLV record of the received data.

According to various exemplary embodiments, the first electronic device 101 may identify the information on the communication module included in the second electronic device 102 based on the data received from the second electronic device 102 through the NFC. For example, the information on the communication module included in the second electronic device 102 may include a variety of information, such as the communication module included in the second electronic device 102, the performance of the communication module, an on/off state of the communication module, information on whether the second electronic device 102 is connected with another electronic device or not, information on whether the second electronic device 102 transceivers data with another electronic device through at least one communication module, and a password when security is set in the communication module.

Referring to operation 405, the first electronic device 101 may determine (or select) a communication method for transceiving data based on the information on the usable communication module (or the usable communication method) of the second electronic device 102 which is received through the NFC. Herein, the usable communication module or the usable communication method may refer to an module or a communication method for performing short-range wireless communication. For example, the short-range wireless communication may include at least one of the wireless communication methods such as BT communication, BT low energy (BLE) communication, WiFi communication, WiFi-Direct communication, infrared ray (IR) communication, and Zigbee communication. According to an exemplary embodiment, the first electronic device 101 may identify the information on the usable communication method (or a communication module included in the first electronic device 101) through the communication interface 160. The first electronic device 101 may determine at least one of the usable communication methods of the second electronic device 102. According to an exemplary embodiment, the first electronic device 101 may identify the NFC method, by which the first electronic device 101 receives data by contacting the second electronic device 102 as described above, the BT communication method, and the WiFi-Direct communication method as the usable communication method of the second electronic device 102 based on the received data. The first electronic device 101 may determine a connectable communication method in the first electronic device 101 and the second electronic device 102 based on the usable communication method of the second electronic device 102. According to an exemplary embodiment, when the first electronic device 101 identifies the NFC method, the IR communication method, the BT communication method, and the WiFi-Direct communication as the usable communication method in the first electronic device 101, the first electronic device 101 may determine the BT communication method and the WiFi-Direct communication method as the communication method connectable with the second electronic device 102.

According to various exemplary embodiments, the first electronic device 101 may determine at least one communication method for transceiving data from among the communication methods connectable with the second electronic device 102. According to an exemplary embodiment, the first electronic device 101 may determine a communication method having a high priority as the communication method for connecting with the second electronic device 102 based on a communication priority list of setting information of the memory 130. For example, the first electronic device 101 may determine the WiFi-Direct communication method having a higher priority than that of the BT communication method in the communication priority list as the communication method for connecting with the second electronic device. 102.

According to an exemplary embodiment, the first electronic device 101 may determine a communication method having a high data transceiving speed as the communication method for connecting with the second electronic device 102. For example, the first electronic device 101 may determine the communication speed of each of the communication methods by transmitting packet data for measuring the data transceiving speed to the second electronic device 102 and receiving a response from the second electronic device 102 in at least one of the BT communication method and the WiFi-Direct communication method. The first electronic device 101 may determine a communication method having a high data transceiving speed (for example, the WiFi-Direct communication method) as the communication method for connecting with the second electronic device 102 based on the received response. According to an exemplary embodiment, when the first electronic device 101 determines that a communication module of the communication method for transmitting packet data (for example, the WiFi-Direct) from among the communication modules of the second electronic device 102 is inactivated based on the data received through NFC, the first electronic device 101 may transmit control information for requesting the corresponding communication module (for example, the WiFi-Direct communication module) to be converted into an activation state in the NFC method. When the first electronic device 101 determines that the WiFi-Direct communication module of the second electronic device 102 is activated, the first electronic device 101 may transmit the packet data for measuring the communication speed.

According to various exemplary embodiments, when the first electronic device 101 determines that there is one communication method connectable with the second electronic device 102 based on the received data, it is obvious that the first electronic device determines to connect with the second electronic device 102 in the corresponding communication method.

In operation 407, the first electronic device 101 may establish a communication link with the second electronic device 102 in the determined communication method. According to an exemplary embodiment, when the determined communication method is the WiFi-Direct communication method, the first electronic device 101 may connect with the second electronic device 102 through the WiFi-Direct communication.

According to an exemplary embodiment, when the first electronic device 101 determines to connect with the second electronic device 102 through the WiFi-Direct communication, the first electronic device 101 may determine that the WiFi-Direct module of the second electronic device 102 is inactivated. The first electronic device 101 may transmit control information for requesting the WiFi-Direct module in the inactivation state to be converted into the activation state to the second electronic device 102 through the NFC. After transmitting the control information, the first electronic device 101 may determine that the WiFi-Direct module of the second electronic device 102 is converted into the activation state, and may connect with the second electronic device 102 in the WiFi-Direct communication method. According to an exemplary embodiment, the first electronic device 101 may determine whether the WiFi-Direct module of the second electronic device 102 is activated or not based on data which is received through the NFC in response to the data including the control information, which is transmitted to the second electronic device 102 through the NFC. For example, the second electronic device 102 may convert the WiFi-Direct module of the second electronic device 102 into the activation state based on the received control information. The second electronic device 102 may transmit data including information identifying that the WiFi-Direct module is converted into the activation state to the first electronic device 101 through the NFC.

According to various exemplary embodiments, in transmitting the control information to the second electronic device 102, the first electronic device 101 may include information necessary for allowing the second electronic device 102 to connect with the first electronic device 101 in the WiFi-Direct communication method in the control information, and transmit the information. For example, the first electronic device 101 may include information such as device identification information of the WiFi-Direct module and a password when security is set in the WiFi-Direct communication in the control information, and transmit the control information to the second electronic device 102 through the NFC. Accordingly, when the first electronic device 101 and the second electronic device 102 connect with each other through the WiFi-Direct communication, the first electronic device 101 is not limited to requesting connection with the second electronic device 101 through the WiFi-Direct communication, and may connect the WiFi-Direct communication based on a WiFi-Direct connection request received from the second electronic device 102 based on the information transmitted through the NFC.

According to various exemplary embodiments, when the first electronic device 101 determines to connect with the second electronic device 102 in the BT communication method based on the data received through the NFC, the first electronic device 101 may determine whether the first electronic device 101 is paired with the second electronic device 102 through the BT communication. When the first electronic device 101 is paired with the second electronic device 102 through the BT communication, the first electronic device 101 may request connection, and, when the first electronic device 101 is not paired with the second electronic device 102, the first electronic device 101 may request BT pairing and request connection with the second electronic device 102.

Referring to operation 409, the first electronic device 101 may transmit designated data to the second electronic device 102 through the connected communication method. According to an exemplary embodiment, the first electronic device 101 may transmit and/or receive the designated data in the connected communication method (for example, the WiFi-Direct communication method) from among the communication methods usable in the second electronic device 102 based on the data received through the NFC as described above. Herein, the designated data which is transmitted and/or received by the first electronic device 101 may be data which is selected based on a user input before the NFC connection is detected in operation 401, or may be data which is designated while one of the operations of FIG. 4 is performed. For example, the first electronic device 101 may perform operation 401 in the state in which at least one data is selected based on a user's input. Furthermore, in operation 409, the first electronic device 101 may transmit and/or receive the data which is selected based on a user's input while at least one of operations 401-409 is performed to and/or from the second electronic device 102. Furthermore, the first electronic device 101 may transmit data selected based on a user's input to the second electronic device 102 through the connected WiFi-Direct communication even after having transmitted and/or received the designated data.

When operation 409 is performed, the first electronic device 101 may finish the exemplary embodiment of FIG. 4. Furthermore, when operation 409 is performed, the first electronic device 101 may disconnect the NFC from the second electronic device 102.

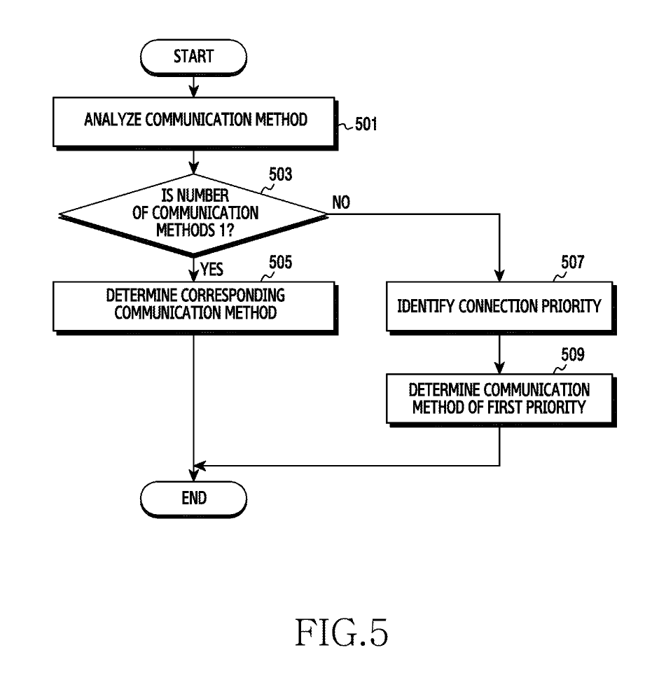

FIG. 5 illustrates a flowchart showing an operation of determining a communication method for connecting with another electronic device in the electronic device according to various exemplary embodiments.

According to various exemplary embodiments, the first electronic device 101 may determine a short-range wireless communication method for connecting with another electronic device (for example, the second electronic device 102) connected therewith through NFC by performing at least one operation of operations 501 to 507 explained in FIG. 5. According to an exemplary embodiment, the embodiments of FIG. 5 may be a part of the operations performed through operation 405 of FIG. 4.

Referring to operation 501, the first electronic device 101 may analyze communication methods usable in the second electronic device 102 based on data received from the second electronic device 102 through NFC. According to an exemplary embodiment, the first electronic device 101 may identify a variety of information such as the number of communication methods usable in the second electronic device 102, the types of the communication methods, and device identification information of the communication module based on the received data.

Referring to operation 503, the first electronic device 101 may determine the number of communication methods usable in the second electronic device 102 based on the data received through the NFC. According to an exemplary embodiment, the first electronic device 101 may determine whether the number of communication methods connectable with the second electronic device 102 through short-range wireless communication is 1 or not. For example, when the number of communication methods connectable with the second electronic device 102 through short-range wireless communication is determined as 1, the first electronic device 101 may perform operation 505. When the number of communication methods connectable with the second electronic device 102 through the short-range wireless communication is determined as two or more, the first electronic device 102 performs operation 507.

Referring to operation 505, when the number of communication methods connectable with the second electronic device 102 through the short-range wireless communication is determined as 1, the first electronic device 101 may determine to connect with the second electronic device 102 in the corresponding communication method (for example, the BT communication method).

Referring to operation 507, when the number of communication methods connectable with the second electronic device 102 through the short-range wireless communication is determined as two or more, the first electronic device 101 may determine at least one communication method having a high connection priority from among the communication methods connectable with the second electronic device 102. According to an exemplary embodiment, the connection priority list included in the memory of the first electronic device 101 may be a list for designating a communication method that may be connected first when two or more wireless communication methods are connectable. For example, the connection priority list may be determined based on a data transceiving speed of a communication method. For example, when the connection priority list includes the BT communication method and the WiFi-Direct communication method, the first electronic device 101 may determine that the WiFi-Direct communication method having a high data transceiving speed is of a higher priority than the BT communication method. Herein, the priority of the communication method designated in the connection priority list may be determined by the first electronic device 101 as described above. However, the connection priority list of the designated priorities may be received from an external device (for example, the server 106 or another electronic device).

Referring to operation 509, when the first electronic device 101 determines one communication method from among the two or more communication methods, the first electronic device 101 may determine to connect with the second electronic device 102 in a communication method having a high priority with reference to the connection priority list included in the memory 130 of the first electronic device 101. According to an exemplary embodiment, when the first electronic device 101 determines the BT communication method and the Win-Direct communication method as the connectable communication method, the first electronic device 101 may determine the communication method having the high priority (for example, the WiFi-Direct communication method) with reference to the connection priority list.

When the first electronic device 101 performs operation 505 or 509, the first electronic device 101 may finish the exemplary embodiment of FIG. 5 or may perform operation 407 of FIG. 4.

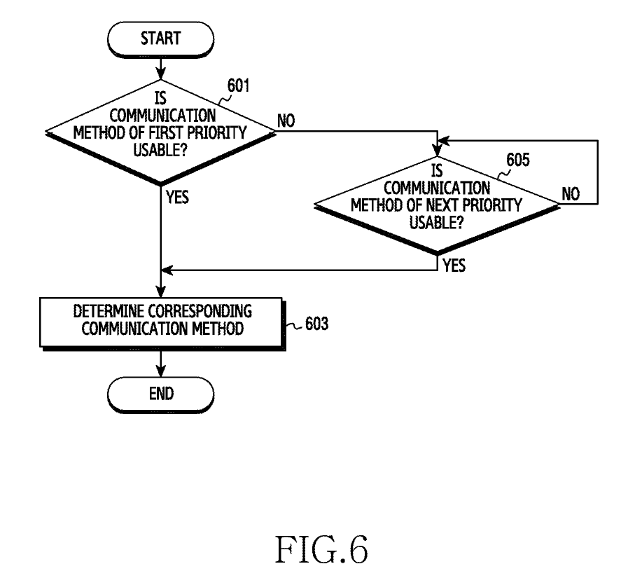

FIG. 6 illustrates a flowchart showing an operation of determining a communication method for connecting with another electronic device in the electronic device according to various exemplary embodiments.

According to various exemplary embodiments, the first electronic device 101 may determine a short-range wireless communication method for connecting with another electronic device (for example, the second electronic device 102) connected therewith through NFC by performing at least one of operations 601 to 605 explained in FIG. 6. According to an exemplary embodiment, the exemplary embodiments of FIG. 6 may be a part of operations performed through operation 507 of FIG. 5.

Referring to operation 601, the first electronic device 101 may determine whether the first electronic device 101 is able to connect with the second electronic device 102 in a communication method of a first priority (for example, the WiFi-Direct) or not based on the connection priority list included in the memory 130. The first electronic device 101 may identify information on at least one communication module included in the second electronic device 102 based on data received from the second electronic device 102 through NFC. For example, the first electronic device 101 may identify an operation state of the communication module, such as information on whether the WiFi-Direct communication module included in the second electronic device 102 is in a connection standby state or is in use. When it is determined that the first electronic device 101 is able to connect with the second electronic device 102 in the communication method of the first priority (for example, the WiFi-Direct), the first electronic device 101 may perform operation 603, and, when it is determined that the first electronic device 101 is not able to connect with the second electronic device 102 in the communication method of the first priority (for example, the WiFi-Direct), the first electronic device 101 may perform operation 605. Herein, it may be determined that the first electronic device 101 is not able to connect with the second electronic device 102 in the communication method of the first priority (for example, the WiFi-Direct) when it is determined that the second electronic device 102 does not support the communication method given the first priority (for example, the WiFi-Direct communication method) (for example, the second electronic device 102 does not include the corresponding communication module) based on information acquired from the data received from the second electronic device 102 through NFC, or when the first electronic device 101 transmits test packet data in the communication method given the first priority (for example, the WiFi-Direct communication method), but does not receive a response within a predetermined time.

Referring to operation 605, the first electronic device 101 may determine whether the first electronic device 101 is able to connect with the second electronic device 102 in a communication method given the next priority of the first priority (for example, the second priority) or not with reference to the connection priority list. According to an exemplary embodiment, the first electronic device 101 may identify an operation state of a communication module. such as information on whether the communication method given the second priority (for example, the BT communication method) is in a connection standby state or in use. When it is determined that the first electronic device 101 is able to connect with the second electronic device 102 in the communication method of the next priority, which is placed after the communication method of the first priority determined not to be connectable, the first electronic device 101 performs operation 603, and when it is determined that the first electronic device 101 is not able to connect with the second electronic device 102 in the communication method of the next priority, the first electronic device 101 may repeat operation 605.

According to an exemplary embodiment, in operation 605, the first electronic device 101 may determine that the first electronic device 101 is not able to connect with the second electronic device 102 in the BT communication method which is given the next priory (for example, the second priority) of the WiFi-Direct communication method given the first priority, and, by repeating operation 605, the electronic device 101 may determine whether the first electronic device 101 is able to connect with the second electronic device 102 in a communication method (for example, the Zigbee communication method) given by the next priority (for example, the third priority) of the previous priority (for example, the second priority). When it is determined that the first electronic device 101 is able to connect with the second electronic device 102 in the third priority communication method, the first electronic device 101 may perform operation 603, and, when it is determined that the first electronic device is not able to connect with the second electronic device 102 in the third priority communication method, the first electronic device 101 may repeat operation 605.

Referring to operation 603, the first electronic device 101 may determine to connect with the second electronic device 102 in the communication method which is determined as being connectable with the second electronic device 102 based on the connection priority list. According to an exemplary embodiment, the first electronic device 101 may determine to connect with the second electronic device 102 in the communication method (for example, the WiFi-Direct communication method) identified by performing operation 601, or the communication method (for example, the BT communication method or the communication method given the next priority by repeating operation 605) identified by performing operation 605.

When operation 603 is performed, the first electronic device 101 may finish the exemplary embodiment of FIG. 6, or may perform operation 407 of FIG. 4.

According to various exemplary embodiments, an operation method of an electronic device may include: connecting with another electronic device in an NFC method; identifying information on connectable short-range wireless communication of another electronic device in the process of connecting; setting a short-range wireless communication method for connecting with another electronic device based on the identified short-range wireless communication information; and transmitting or receiving data to or from another electronic device through the set short-range wireless communication method. According to an exemplary embodiment, the connecting may include connecting with another electronic device by using a logical link control protocol (LLCP) according to the NFC method, and exchanging records including a type, a length, and a value according to the LLCP. According to an exemplary embodiment, at least one of the records may include a value indicating the information on the connectable short-range wireless communication of another electronic device. According to an exemplary embodiment, at least one of the records may include at least one of the values indicating that another electronic device is connectable only through first short-range wireless communication, or that another electronic device is connectable through both the first short-range wireless communication and second short-range wireless communication.

According to various exemplary embodiments, an operation method of an electronic device includes: establishing a first communication link when connection with another electronic device is detected; receiving second communication information of connectable short-range wireless communication types from detected another electronic device through the first communication link; setting a short-range wireless communication link with another electronic device based on the second communication information; and transmitting or receiving data to or from another electronic device through the short-range wireless communication link. According to an exemplary embodiment, the detecting the connection may include detecting contact with another electronic device. According to an exemplary embodiment, the first communication link may be NFC. According to an exemplary embodiment, the second communication information may include at least one of the values indicating that another electronic device is connectable only through first short-range wireless communication or is connectable through both the first short-range wireless communication and second short-range wireless communication.

According to an exemplary embodiment, the first short-range wireless communication may be BT communication and the second short-range wireless communication may be WiFi-Direct communication. According to an exemplary embodiment, when it is determined that another electronic device is connectable only through the BT communication based on the identified short-range wireless communication information, the setting may include setting the short-range wireless communication method for connecting with another electronic device as the BT communication. According to an exemplary embodiment, when it is determined that another electronic device is connectable through both the BT communication and the WiFi-Direct communication based on the identified short-range wireless communication information, the setting may include setting the short-range wireless communication method for connecting with another electronic device as the WiFi-Direct communication.

According to an exemplary embodiment, when another electronic device is connectable through both the BT communication and the WiFi-Direct communication, both the BT communication and the WiFi-Direct communication may be activated in the process of connecting with another electronic device. According to an exemplary embodiment, when the set short-range wireless communication method is the BT communication, the transmitting or receiving may include transmitting or receiving data to or from another electronic device through the BT communication. According to an exemplary embodiment, when the set short-range wireless communication method is the Win-Direct communication, the transmitting or receiving may include transmitting or receiving data to or from another electronic device through the WiFi-Direct communication.

According to various exemplary embodiments, an operation method of an electronic device includes: when another device is detected, establishing a first communication link using a first short-range wireless communication method; receiving information on other short-range wireless communication methods usable by another electronic device through the first communication link; selecting a second short-range wireless communication method from the other short-range wireless communication methods included in the received information; establishing a second communication link with another electronic device based on the second short-range wireless communication method; and transmitting or receiving data to or from another electronic device using the second communication link. According to an exemplary embodiment, the detecting another electronic device may include detecting contact with another electronic device. According to an exemplary embodiment. the first short-range wireless communication method may be an NFC method.

According to an exemplary embodiment, the at least one short-range wireless communication method may include at least one of WiFi, WiFi-Direct, and BT methods. According to an exemplary embodiment, the information may include at least one of the values indicating that another electronic device is connectable only through the first short-range wireless communication or that another electronic device is connectable through both the first short-range wireless communication and the second short-range wireless communication. According to an exemplary embodiment, the receiving the information on the other short-range wireless communication methods usable by another electronic device through the first communication link may include receiving the information including a TLV record generated based on an LLC protocol. According to an exemplary embodiment, the selecting the second short-range wireless communication method from the other short-range wireless communication methods included in the received information may further include identifying the other short-range wireless communication methods based on information included in at least one of type or tag, length, and value fields of the TLV record. According to an exemplary embodiment, the second short-range wireless communication method may be a WiFi-Direct method.

According to an exemplary embodiment, the selecting the second short-range wireless communication method from the other short-range wireless communication methods may include, when it is determined that another electronic device is able to use the BT method and the WiFi-Direct method based on the information on the other short-range wireless communication methods, selecting the WiFi-Direct method as the second short-range wireless communication method. According to an exemplary embodiment, when another electronic device is connectable through both the BT method and the WiFi-Direct method, both the BT method and the WiFi-Direct method are activated at the time when the information on the other short-range wireless communication methods usable by another electronic device is transmitted to the electronic device through the first communication link.

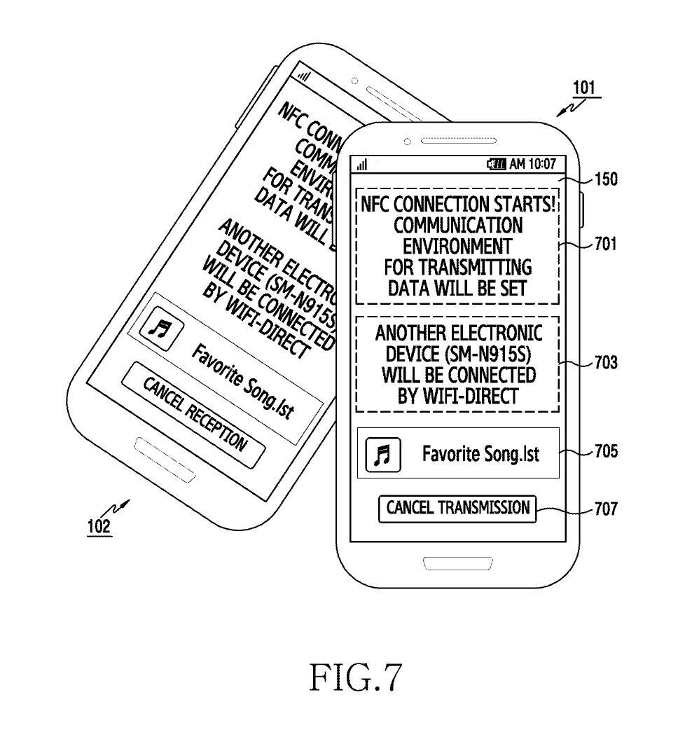

FIG. 7 illustrates a view showing transceiving data through short-range wireless communication connected with another electronic device in the electronic device according to various exemplary embodiments.

According to various exemplary embodiments, the first electronic device 101 may display information on an operation of connecting with the second electronic device 102 through short-range wireless communication and transmitting and/or receiving data on the display 150 through a graphic interface. According to an exemplary embodiment, when the first electronic device 101 contacts the second electronic device 102 through a data transceiving mode in an NFC method, the first electronic device 101 may display information on the state of the first electronic device 101 contacting through the NFC, and information on an operation of setting a communication environment for transceiving data (for example, information 701).

Furthermore, when the first electronic device 101 determines short-range wireless communication for transceiving data and/or connects with the second electronic device 102 through the determined short-range wireless communication, the first electronic device 101 may display information on the connection state and information on the data transceiving state (for example, information 705). Furthermore, the first electronic device 101 may display information (for example, information 705) on data which is transmitted to the second electronic device 102 through connected short-range wireless communication and/or is received from the second electronic device 102. Furthermore, the first electronic device 101 is not limited to the above-described explanation, and may further display information such as a speed of the first electronic device 101 transceiving data with the second electronic device 102 through connected short-range wireless communication, and a priority of the connected short-range wireless communication (for example, a priority designated in the connection priority list included in the first electronic device 101).

According to various exemplary embodiments, the first electronic device 101 may stop (or cancel) transmitting and/or receiving data to and/or from the second electronic device 102 by identifying a user input to select a function menu (for example, a menu 707) displayed on the display 150. Likewise, the first electronic device 101 may disconnect at least one communication of the NFC and the short-range wireless communication connected with the second electronic device 102 based on a menu provided through the display 150.

In the above-described exemplary embodiments, the first electronic device 101 may provide information on the data transceiving operation and receive the user input through the display 150. However, this may not be considered as limiting. The first electronic device 101 may output the corresponding information as an audio through the speaker 282 included in the first electronic device 101. Furthermore, in receiving the user input, the first electronic device 101 provides a menu displayed on the display 150 to select. However, this may not be considered as limiting. The electronic device 101 may perform a corresponding operation by receiving control information designated by a user voice through the microphone 288, or identifying control information which is inputted through at least one sensor (for example, an acceleration sensor, a speed sensor, a tilt sensor, a gyro sensor, etc.) included in the first electronic device 101.

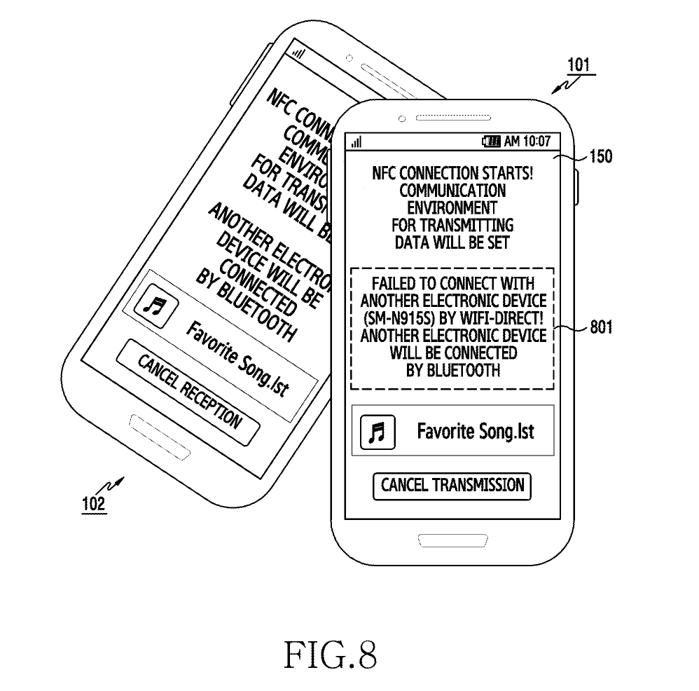

FIG. 8 illustrates a view showing transceiving data through short-range wireless communication connected with another electronic device in the electronic device according to various exemplary embodiments.

According to various exemplary embodiments, the first electronic device 101 may connect short-range wireless communication for transceiving data with the second electronic device 102 based on information on a communication module of the second electronic device 102, which is received through NFC. In connecting with the second electronic device 102 through designated short-range wireless communication based on the received information on the communication module of the second electronic device 102, the first electronic device may display information on communication methods which are not connected through the display 150 of the first electronic device 101. According to an exemplary embodiment, when the first electronic device 101 requests communication connection with the second electronic device 102 in the communication method (for example, the WiFi-Direct) determined to connect with the second electronic device 102 with reference to the connection priority list, but is not connected with the second electronic device 102, the first electronic device 101 may display corresponding information on the display 150.

In addition, when the communication method determined with reference to the connection priority list is not supported by the second electronic device 102 (for example, the communication module is not included in the second electronic device 102), the first electronic device 101 may display corresponding information on the display 150. When the first electronic device 101 is not connected with the second electronic device 102 in the designated communication method, the first electronic device 101 may request connection with the second electronic device 102 in another communication method (for example, a communication method of the next priority), and display information on the connected communication method (for example, information 801) on the display 150.

Various exemplary embodiments performed by the first electronic device 101 may be operations which are performed under the control of the processor 120. Furthermore, the first electronic device 101 may include a module which is programmed to control various exemplary embodiments of the present disclosure and is separate from the processor 120. The separate module programmed to control various exemplary embodiments of the present disclosure may be operated under the control of the processor 120.

According to various exemplary embodiments, the processor 120 may establish a first communication link using a first short-range wireless communication method when detecting another electronic device, receive information on other short-range wireless communication methods usable by another electronic device through the first communication link, select a second short-range wireless communication method from among the other short-range wireless communication methods included in the received information, establish a second communication link with another electronic device based on the second short-range wireless communication method, and transmit or receive data to or from another electronic device using the second communication link.

According to an exemplary embodiment, the processor 120 may detect another electronic device by detecting contact with another electronic device. According to an exemplary embodiment, the processor 120 may control an NFC module which uses an NFC method as the first short-range wireless communication method. According to an exemplary embodiment, the processor 120 may control at least one of WiFi, WiFi-Direct, and BT methods as at least one short-range wireless communication method. According to an exemplary embodiment, the processor 120 may acquire, from the information, at least one of values indicating that another electronic device is connectable only through the first short-range wireless communication or that another electronic device is connectable through both the first short-range wireless communication and the second short-range wireless communication.

According to an exemplary embodiment, the processor 120 may receive the information on the other wireless communication methods usable by another electronic device, which includes a TLV record generated based on an LLC protocol, through the first communication link. According to an exemplary embodiment, the processor 120 may identify the other short-range wireless communication methods based on information included in at least one of type or tag, length, and value fields of the TLV record. According to an exemplary embodiment, the processor 120 may control a WiFi module which uses the WiFi-Direct method as the second short-range wireless communication method. According to an exemplary embodiment, when it is determined that another electronic device is connectable through both the BT method and the WiFi-Direct method based on the information on the other short-range wireless communication methods, the processor 120 may select the WiFi-Direct method as the second short-range wireless communication method.

According to various exemplary embodiments, the electronic device may include a first communication module, a second communication module, a third communication module, and the processor 120 for controlling the modules. The processor 120 may control the first communication module to connect with another electronic device in an NFC method, identify connectable short-range wireless communication information of another electronic device in the connecting process, set a short-range wireless communication method for another electronic device, and control one of the second communication module and the third communication module according to the set short-range wireless communication method to transmit or receive data to or from another electronic device.

According to an exemplary embodiment, the processor 120 may control the first communication module to connect with another electronic device by using a logical link control protocol according to the NFC method, and exchanging records including a type, a length, and a value according to the logical link control protocol. According to an exemplary embodiment, at least one of the records may include at least one of the values indicating that another electronic device is connectable only through first short-range wireless communication, or that another electronic device is connectable through both the first short-range wireless communication and second short-range wireless communication.

According to various exemplary embodiments, the processor 120 may control the first communication module to establish a first communication link when connection with another electronic device is detected, receive second communication information of a connectable short-range wireless communication type from detected another electronic device through the first communication link, set a short-range wireless communication link with another electronic device based on the second communication information, and transmit or receive data to or from another electronic device through the short-range wireless communication link. According to an exemplary embodiment, the processor 120 may detect the connection by contacting another electronic device. According to an exemplary embodiment, the first communication link may be NFC. According to an exemplary embodiment, the second communication information may include at least one of the values indicating that another electronic device is connectable only through first short-range wireless communication, or that another electronic device is connectable through both the first short-range wireless communication and second short-range wireless communication.

According to an exemplary embodiment, the first communication module may be an NFC module, the second communication module may be a BT communication module, and the third communication module may be a WiFi communication module, and the first short-range wireless communication may be BT communication and the second short-range wireless communication may be WiFi-Direct communication. According to an exemplary embodiment, when it is determined that another electronic device is connectable only through the BT communication based on the identified short-range wireless communication information, the processor 120 may set the short-range wireless communication method for another electronic device as the BT communication. According to an exemplary embodiment, when it is determined that another electronic device is connectable through both the BT communication and the WiFi-Direct communication based on the identified short-range wireless communication information, the processor 120 may set the short-range wireless communication method for another electronic device as the WiFi-Direct communication.

According to an exemplary embodiment, when another electronic device is connectable through both the BT communication and the WiFi-Direct communication, both the BT communication and the WiFi-Direct communication may be activated in the process of connecting with the electronic device. According to an exemplary embodiment, when the set short-range wireless communication method is the BT communication, the processor 120 may control a BT communication module to transmit or receive data to or from another electronic device. According to an exemplary embodiment, when the set short-range wireless communication method is the WiFi-Direct communication, the processor 120 may control a WiFi-Direct communication module to transmit or receive data to or from another electronic device 102.

According to various exemplary embodiments, when the electronic device and the second electronic device 102 are connectable using a plurality of short-range wireless communication methods in setting a communication environment between the first electronic device and the second electronic device 102, the processor 120 may set a communication link of a specific short-range wireless communication method with the second electronic device based on a designated priority. According to an exemplary embodiment, the first electronic device 101 may determine the priority of at least one short-range wireless communication method according to a user input, a size or number of data to be transmitted, and a communication environment of the short-range wireless communication method. In setting the communication link of the short-range wireless communication method, the first electronic device 101 may set two or more short-range wireless communication method simultaneously.

Each of the above-described elements of the electronic device according to various embodiments of the present disclosure may be comprised of one or more components, and the names of the elements may vary according to the kind of the electronic device. The electronic device according to various embodiments of the present disclosure may include at least one of the above-described elements, and some of the elements may be omitted or an additional element may be further included. In addition, some of the elements of the electronic device may be combined into a single entity, and may perform the same functions as those of the elements before being combined.

According to various exemplary embodiments, at least part of the apparatus and method based on the embodiments disclosed in the claims and/or specification of the present disclosure may refer to a establish (for example, a module, an interface, device, or a unit) including hardware, software, firmware, or a combination of one or two or more of the hardware, software, and the firmware, or may be implemented in hardware, software, firmware, or a combination of one or two or more of the hardware, software, and the firmware. The “module” may be used interchangeably with terms like unit, logic, logical block, component or circuit. The “module” may be a minimum unit of an integrally configured part or a part of the minimum unit of the integrally configured part. Furthermore, the “module” may be a minimum unit that performs one or more functions in various exemplary embodiments of the present disclosure or a part of the minimum unit that performs one or more functions. The “module” may be implemented mechanically or electronically.

For example, the “module” may include at least one of an Application Specific Integrated Circuit (ASIC) chip, Field Programmable Gate Arrays (FPGAs), and a programmable logic device, and may perform any operation that is already well known or will be developed in the future. Furthermore, the “module” may be provided to a computer-readable storage medium which stores one or more programs (or programming modules or applications). For example, the software may be implemented by instructions stored in the computer-readable storage medium in the form of a programming module. The one or more programs may include instructions to allow the electronic device to execute the methods according to the exemplary embodiments disclosed in the claims and/or specification of the present disclosure. When the instructions are executed by one or more processors (for example, the processor 120), the one or more processors may perform a function corresponding to the instructions. The computer-readable storage medium may be the memory 230, for example. At least part of the programming module may be implemented (for example, executed) by the processor 220. At least part of the programming module may include a module, a program, a routine, sets of instructions, or a process to perform one or more functions, for example.

The computer-readable recording medium includes magnetic media such as hard disks, floppy disks, and magnetic tapes, optical media such as compact disc read only memories (CD-ROMs) and digital versatile disc (DVDs), magneto-optical media such as floptical disks, hardware devices such as ROMs. RAMs and flash memories that are especially configured to store and execute program commands (for example, a programming module), an electrically erasable programmable read only memory (EEPROM), a magnetic disc storage device or other forms of optical storage devices, and a magnetic cassette. Alternatively, the program may be stored in a memory configured in combination of all or some of these storage media. In addition, the configured memory may be plural in number. In addition, the program commands include machine language codes created by a compiler, and high-level language codes that can be executed by a computer by using an interpreter.

According to various exemplary embodiments, an electronic device includes a computer-readable storage medium, which stores a program for performing a method, the method including: establishing a first communication link using a first short-range wireless communication method when another electronic device is detected; receiving information on other short-range wireless communication methods usable in the another electronic device through the first communication link; selecting a second short-range wireless communication method from among the other short-range wireless communication methods included in the received information; establishing a second communication link with the another electronic device based on the second short-range wireless communication method; and transmitting or receiving data to or from the another electronic device using the second communication link.

According to various exemplary embodiments, an electronic device may include a computer-readable storage medium which stores a program for performing a method, including: connecting with another electronic device in an NFC method; identifying connectable short-range wireless communication information of another electronic device in the connecting process; setting a short-range wireless communication method for another electronic device based on the identified short-range wireless communication information; and transmitting or receiving data to or from another electronic device through the set short-range wireless communication method.

Furthermore, the program may be stored in an attachable storage device capable of accessing the electronic device through a communication network such as the Internet, an intranet, a local area network (LAN), a wide LAN (WLAN), or a storage area network (SAN) or a communication network configured by combining the above networks. The storage device may access the electronic device via an external port. In addition, a separate storage device on the communication network may access a portable electronic device. The above-described hardware devices may be configured to operate as one or more software modules for performing operations of various exemplary embodiment of the present disclosure, and vice versa.

A module or programming module according to various exemplary embodiments may include one or more of the above-described elements, may omit some elements, or may further include additional other elements. The operations performed by the module, the programming module, or the other elements according to various exemplary embodiments may be performed serially, in parallel, repeatedly, or heuristically. In addition, some operation may be performed in different order or may be omitted, and additional other operations may be added.

According to various exemplary embodiments of the present disclosure, the electronic device connects with another electronic device in a first communication method, and automatically determines a second communication method based on data transceived in the first communication method, so that an efficient user interface can be provided.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An operation method of an electronic device, the method comprising:
establishing a first communication link with another electronic device using a first short-range wireless communication method;
receiving information using at least one usable short-range wireless communication method from the other electronic device through the first communication link;
selecting a second short-range wireless communication method from the at least one usable short-range wireless communication method included in the received information;
establishing a second communication link with the other electronic device using the second short-range wireless communication method; and
transmitting data to the other electronic device over the second communication link or receiving data from the other electronic device over the second communication link.

2. The operation method of claim 1, further comprising detecting a contact with the other electronic device.

3. The operation method of claim 1, wherein the first short-range wireless communication method is an NFC method.

4. The operation method of claim 1, wherein the at least one usable short-range wireless communication method comprises at least one of WiFi communication method, WiFi-Direct communication method, and BT communication method.

5. The operation method of claim 1, wherein the information comprises at least one of values indicating that the other electronic device is connectable only in the first short-range wireless communication method or that the other electronic device is connectable in both the first short-range wireless communication method and the second short-range wireless communication method.

6. The operation method of claim 1, wherein receiving the information using the at least one usable short-range wireless communication method from the other electronic device through the first communication link comprises receiving the information comprising a type-length-value (TLV) record that is generated based on an logical link control (LLC) protocol.

7. The operation method of claim 6, wherein selecting the second short-range wireless communication method from the at least one usable short-range wireless communication method included in the received information further comprises determining the at least one usable short-range wireless communication method based on information included in at least one of type or tag, length, and value fields of the TLV record.

8. The operation method of claim 1, wherein the second short-range wireless communication method is at least one of a WiFi-Direct communication method or a BT communication method.

9. The operation method of claim 1, wherein selecting the second short-range wireless communication method from the at least one usable short-range wireless communication method comprises, when the other electronic device is able to use a BT communication method and a WiFi-Direct communication method based on the information using the at least one usable short-range wireless communication method, selecting the Win-Direct communication method as the second short-range wireless communication method.

10. The operation method of claim 1, further comprising, when the other electronic de vice is connectable both in the BT communication method and the WiFi-Direct communication method, activating both the BT communication method and the Win-Direct communication method at a time when the information on the at least one usable short-range wireless communication method is transmitted to the electronic device from the other electronic device through the first communication link.

11. An electronic device comprising:
at least one communication module; and
a processor configured to:
establish a first communication link with another electronic device using a first short-range wireless communication method;
receive information using at least one usable short-range wireless communication method from the other electronic device through the first communication link;
select a second short-range wireless communication method from the at least one usable short-range wireless communication method included in the received information;
establish a second communication link with the other electronic device using the second short-range wireless communication method; and
transmit data to the other electronic device over the second communication link or receive data from the other electronic device over the second communication link.

12. The electronic device of claim 11, wherein the processor is further configured to detect the other electronic device by detecting a contact with the other electronic device.

13. The electronic device of claim 11, wherein the processor is further configured to control an NFC module that uses an NFC protocol as the first short-range wireless communication method.

14. The electronic device of claim 11, wherein the processor is configured to select the second short-range wireless communication method at least one of WiFi communication method. WiFi-Direct communication method, and BT communication method.

15. The electronic device of claim 11, wherein the processor is configured to acquire, from the information, at least one of values indicating that the other electronic device is connectable only in the first short-range wireless communication method or that the other electronic device is connectable in both the first short-range wireless communication method and the second short-range wireless communication method.

16. The electronic device of claim 11, wherein the processor is configured to receive the information using the at least one usable short-range wireless communication method, that comprises a type-length-value (TLV) record generated based on an logical link control (LLC) protocol, from the other electronic device through the first communication link.

17. The electronic device of claim 16, wherein the processor is configured to determine the at least one usable short-range wireless communication method based on information included in at least one of type or tag, length, and value fields of the TLV record.

18. The electronic device of claim 14, wherein the processor is configured to control a communication module that uses at least one of a WiFi-Direct communication method or a BT communication method as the second short-range wireless communication method.

19. The electronic device of claim 11, wherein, when the other electronic device is able to use a BT communication method and a WiFi-Direct communication method based on the information using the at least one usable short-range wireless communication method, the processor is further configured to select the WiFi-Direct communication method as the second short-range wireless communication method.

20. A non-transitory computer-readable storage medium comprising program code, that when executed by at least one processor, causes the at least one processor to:
establish a first communication link with another electronic device using a first short-range wireless communication method;
receive information using at least one usable short-range wireless communication method from the other electronic device through the first communication link;
select a second short-range wireless communication method from the at least one usable short-range wireless communication method included in the received information;
form a second communication link with the other electronic device using the second short-range wireless communication method; and
transmit data to the other electronic device over the second communication link or receive data from the other electronic device over the second communication link.
